(19) United States
(12) Patent Application Publication
(10) Pub. No.: US 2006/0077831 A1
(43) Pub. Date: Apr. 13, 2006

(54) Optical disk recording device and method for recording data at high record-speed on low record speed optical disk

(75) Inventor: Min-seok Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/243,317

(22) Filed: Oct. 5, 2005

(30) Foreign Application Priority Data
Oct. 8, 2004 (KR) 10-2004-0080215

(51) Int. Cl. G11B 7/0045

(52) U.S. Cl. 369/47.29; 369/59.11; 369/47.1; 369/47.37

(57) ABSTRACT

An optical disk recording method, and an optical disk recording device to perform the method, the method including generating an over speed write pulse string so that a data recording operation on an optical disk is performed at a record speed exceeding an allowable record speed of the optical disk, and recording data on the optical disk using the generated over speed write pulse string.

### CROSS-REFERENCE TO RELATED APPLICATIONS

This application claims the benefit of Korean Patent Application No. 2004-80215, filed on Oct. 8, 2004, in the Korean Intellectual Property Office, the disclosure of which is incorporated herein by reference.

### BACKGROUND OF THE INVENTION

1. Field of the Invention

The present invention relates in general to an optical disk recording device and a method of operating the same, and, more specifically, to an optical disk recording device to record, and method of recording, data at a designated record speed on a low record-speed optical disk.

2. Description of the Related Art

Optical disk recording devices record data on optical disks at designated record speeds (e.g., single-speed, double-speed (2×), quad-speed (4×), odo-speed (8×), and so on). Although a user is able to choose a desired record speed, there are certain limitations on their choices.

One of the record-speed limiting factors is the optical disk recording device being used to record the data on the optical disk. This means that the user cannot record data at a higher record speed than a maximum record speed set in the optical disk recording device.

Another record-speed limiting factor is the optical disk itself. As a rule, different kinds of optical disks have different ‘allowable record speeds’ (which will hereinafter be referred to simply as ‘allowable speed’). Therefore, data recording must be performed at a lower speed than, or equal to, a given allowable speed. For instance, if the maximum allowable speed of an optical disk is a quad speed, then single, double or quad speed recording may be possible. It is impossible, however, to increase the data record speed up to, or higher than, the odo-speed.

Even though a number of schemes for recording data on an optical disk within ‘allowable speeds’ have been suggested, there have not been any schemes developed for recording data at ‘over speeds’.

In practice, though, there are situations where data needs to be recorded on an optical disk at an ‘over speed’. For instance, in a case where the user wants to finish data recording on an optical disk within a shorter amount of time, or an optical disk recording device has an operational error, data recording even at an allowable speed becomes impossible or inappropriate.

Therefore, there exists a need for developing a scheme for recording data on an optical disk at an ‘over speed’ (that is, high-speed data recording on a low record-speed optical disk).

### SUMMARY OF THE INVENTION

It is, therefore, an aspect of the present invention to provide an optical disk recording device, and method of operating the device, to record data on a low record-speed optical disk at a high record speed or an ‘over speed’, or otherwise record data at a higher speed than that which the optical disk was designed to accommodate.

Additional aspects and/or advantages of the invention will be set forth in part in the description which follows and, in part, will be apparent from the description, or may be learned by practice of the invention.

To achieve the above and/or other aspects and advantages, there is provided an optical disk recording device, including: an optical pickup unit to be driven by an applied write pulse string to record data on an optical disk; and an optical pickup driving unit to generate and apply an over speed write pulse string to the optical pickup unit to that the optical pickup unit records the data on the optical disk at a record speed exceeding an allowable record speed of the optical disk.

The optical pickup driving unit may generate the over speed write pulse string by changing at least one of a start timing, end timing, pulse width, interval between pulses, or a combination thereof, of an allowable speed write pulse string, wherein the allowable speed write pulse string otherwise causes the data recording operation on the optical disk to be performed within the allowable record speed.

The optical pickup driving unit may generate the over speed write pulse string by advancing the start timings of the pulses of the allowable speed write pulse string by a predetermined amount of time, the allowable speed write pulse string being formed of a top-pulse, multi-pulse, last-pulse, cooling-pulse, or a combination thereof.

The optical pickup driving unit may generate the over speed write pulse string by advancing the end timing of the last-pulse by a predetermined amount of time.

The optical pickup driving unit may generate the over speed write pulse string by increasing the pulse widths of a top-pulse, multi-pulse, and last-pulse forming the allowable speed write pulse string by a predetermined amount of time, and reducing the pulse width of a cooling-pulse of the allowable speed write pulse string.

The optical pickup driving unit may generate the over speed write pulse string by reducing an interval between pulses of the allowable speed write pulse string by a predetermined amount of time, the allowable speed write pulse string being formed of a top-pulse, multi-pulse, last-pulse, cooling pulse, or a combination thereof.

The optical disk recording device may further include: an error measurement unit to receive data read from the optical disk, and to measure an error therein; and a controller to control the optical pickup driving unit to generate the over speed write pulse string according to a result of the error measurement.

Also, the error measurement unit may include: an LPPER (Land Pre-Pit Error Rate) measurement unit to measure the LPPER and apply the measured LPPER to the controller; a BER (Byte Error Rate) measurement unit to measure the BER and apply the measured BER to the controller; and/or a jitter measurement unit to measure the jitter and apply the measured jitter to the controller. The controller may generate the over speed write pulse string so that the measured LPPER, BER, jitter, or a combination thereof are below predetermined respective reference LPPER, BER, and jitter values.

Another aspect of the present invention provides an optical disk recording method, the method including: generating an over speed write pulse string so that a data recording operation on an optical disk is performed at a record speed exceeding an allowable record speed of the optical disk; and recording data on the optical disk using the generated over speed write pulse string.

The over speed write pulse string may be generated by changing at least one of a start timing, end timing, pulse width, interval between pulses, or a combination thereof, of an allowable speed write pulse string, wherein the allowable speed write pulse string otherwise causes the data recording operation on the optical disk to be performed within the allowable record speed.

The over speed write pulse string may be generated by advancing the start timings of the pulses of the allowable speed write pulse string by a predetermined amount of time, the allowable speed write pulse string being formed of a top-pulse, multi-pulse, last-pulse, cooling-pulse, or a combination thereof.

The over speed write pulse string may be generated by advancing the end timing of the last-pulse by a predetermined amount of time.

The over speed write pulse string may be generated by increasing the pulse widths of a top-pulse, multi-pulse, and last-pulse forming the allowable speed write pulse string by a predetermined amount of time, and reducing the pulse width of a cooling-pulse of the allowable speed write pulse string.

The over speed write pulse string may be generated by reducing an interval between pulses of the allowable speed write pulse string by a predetermined amount of time, the allowable speed write pulse string is formed of a top-pulse, multi-pulse, last-pulse, or a combination thereof.

The optical disk recording method may further include: receiving data read from the optical disk, and measuring an error therein; and adjusting the generated over speed write pulse string according to a result of the error measurement. Moreover, the error may be an LPPER (Land Pre-Pit Error Rate).

Another aspect of the present invention provides a method of recording data on an optical disk, the method comprising increasing pulse widths of write pulses of an allowable speed write pulse string; wherein an over speed write pulse string is formed so that the data is recorded on the optical disk at a record speed exceeding an allowable record speed of the optical disk.

The pulse widths may be increased by advancing start timings of a top-pulse, multi-pulse, last-pulse, or a combination thereof.

The method may further comprise reducing a pulse width of a cooling-pulse of the allowable speed write pulse string.

The method may further comprise reading one or more error values from the optical disk, and adjusting the pulse widths so that the error values are less than predetermined reference values.

Another aspect of the present invention provides a method of recording data on an optical disk, the method comprising decreasing intervals between write pulses of an allowable speed write pulse string, wherein an over speed write pulse string is formed so that the data is recorded on the optical disk at a record speed exceeding an allowable record speed of the optical disk.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram illustrating an optical disk recording device, capable of recording data on a low record-speed optical disk at a high record-speed, according to one embodiment of the present invention;

FIG. 2A is a timing diagram illustrating an ‘allowable speed write pulse string’ generated by an optical pickup driving unit;

FIG. 2B is a timing diagram illustrating an ‘over speed write pulse string’ generated by an optical pickup driving unit; and

FIG. 3 is a flow chart illustrating a high-speed data recording on a low record-speed optical disk by operation of the optical disk recording device illustrated in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

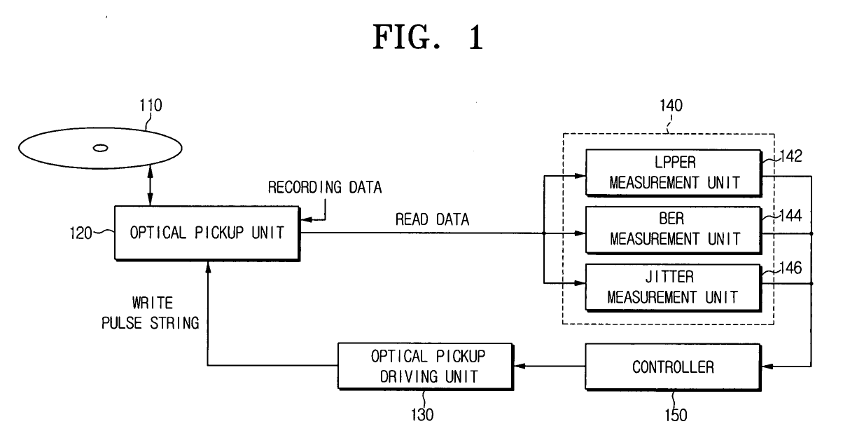

FIG. 1 is a schematic block diagram illustrating an optical disk recording device, capable of performing high-speed data recording on a low record-speed optical disk, according to one embodiment of the present invention. Referring to FIG. 1, the optical disk recording device of the present invention includes an optical pickup unit 120, an optical pickup driving unit 130, an error measurement unit 140, and a controller 150.

The optical pickup unit 120 is driven by an applied write pulse string, and records recording data (that is, data to be recorded) on an optical disk 110 provided in the optical disk recording device. In addition, the optical pickup unit 120 reads data from the optical disc 110, and applies the data to the error measurement unit 140 (to be described).

The optical pickup driving unit 130 generates a write pulse string to use in driving the optical pickup unit 120, and applies the write pulse string to the optical pickup unit 120. Here, write pulse strings generated by the optical pickup driving unit 130 are different according to different record speeds. More detailed explanation regarding the write pulse string, and how the optical pickup driving unit 130 generates the write pulse string, will be provided later in this detailed description.

The error measurement unit 140 receives the data read from the optical disk 110, and measures an error included in the data. This error is later used as a basis or an indicator of a normal data recording, that is, the measured error indicates whether data has been normally recorded by the optical pickup unit 120. As shown in FIG. 1, the error measurement unit 140 includes an LPPER measurement unit 142, a BER measurement unit 144, and a jitter measurement unit 146.

The LPPER (Land Pre-Pit Error Rate) measurement unit 142 measures the LPPER, and applies the measured LPPER to the controller 150. Here, the LPPER refers to a possible damage rate of LPP during the data recording operation on the optical disk 110. Therefore, a lower LPPER means that an appropriate write pulse string is applied to the optical pickup unit 120, and the data recording operation has been normally performed.

The BER (Byte Error Rate) measurement unit 144 measures the BER, and applies the measured BER to the controller 150. Here, the BER refers to an error rate between the recording data and the data recorded and read from the optical disk 110. Therefore, a lower BER means that an appropriate write pulse string is applied to the optical pickup unit 120, and the data recording operation has been normally performed.

The jitter measurement unit 146 measures the magnitude of jitter, and applies the measured jitter magnitude to the controller 150. Jitter occurs mostly due to the optical disk 110 being tilted during the data recording operation on the optical disk 110. Therefore, a smaller jitter magnitude means that the data recording operation has been normally performed.

The controller 150 controls the operation of the optical pickup driving unit 130 associated with the generation of write pulse strings. In detail, the controller 150 determines what kind of write pulse string should be generated by the optical pickup driving unit 130, and controls the optical pickup driving unit 130 to generate the determined write pulse string.

In addition, the controller 150 controls the write pulse strings in consideration of the LPPER, the BER, and the jitter magnitude, so that these are maintained below respective predetermined reference values. To this end, the controller 150 generates a control signal to adjust the write pulse string, and applies the generated control signal to the optical pickup driving unit 130, thereby controlling the write pulse string adjustment operation of the optical pickup driving unit 130.

The following will now explain in more detail the write pulse strings and how the optical pickup driving unit 130 generates the write pulse strings. The write pulse strings can be classified into ‘allowable speed write pulse strings’ and ‘over speed write pulse strings’.

The allowable speed write pulse strings are used when the optical pickup unit 120 records data at a record speed lower than or equal to the allowable speed. For instance, the allowable speed write pulse strings for a single speed optical disk are write pulse strings that are used for recording data on the optical disk 110 at a single speed.

The allowable speed write pulse string is formed of write-pulses and cooling-pulses. End timings (rear edge) of the write-pulses and the cooling-pulses are synchronized with a channel clock with a period T. There are three types of write-pulses: for example, top pulses, multi pulses, and last pulses.

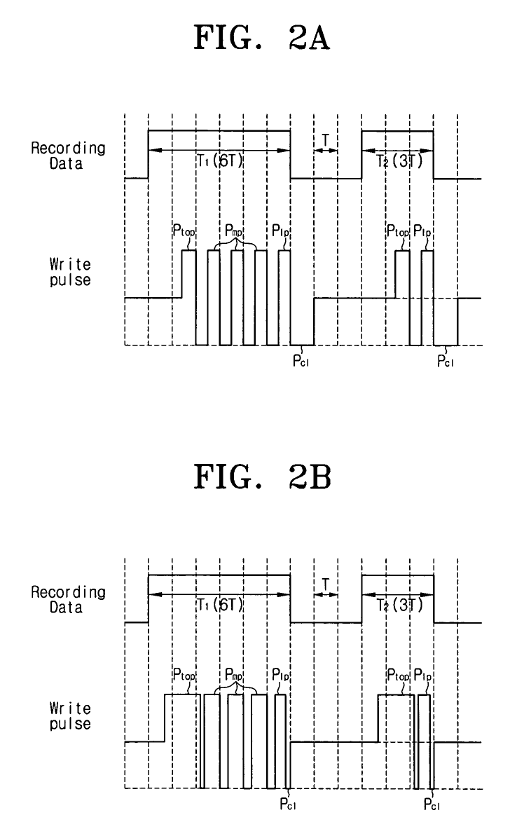

FIG. 2A illustrates one example of the allowable speed write pulse string. As depicted in FIG. 2a, in a first interval T₁ to which recording data is inputted for 6T, a top-pulse Pₜₒₚ, three multi pulses (middle pulses) Pₘₚ, and a last pulse Pₗₚ are generated. Also, a cooling-pulse P_{cl} is generated at the end of the first interval T₁.

In addition, in a second interval T₂ to which recording data is inputted for 3T, a top-pulse Pₜₒₚ, and a last-pulse Pₗₚ are generated. As was the case with the first interval T₁, a cooling-pulse P_{cl} is generated at the end of the second interval T₂.

The over speed write pulse strings are used when the optical pickup unit 120 records data at a higher record speed than the allowable speed of the optical disk 110. For instance, suppose that write pulse strings are used for recording data at a double speed on a single speed optical disk 110. The write pulse strings in that case correspond to the over speed write pulse strings.

Moreover, an over speed write pulse string can be generated by changing an allowable speed write pulse string. More specifically, an over speed write pulse string can be generated by changing the start timings (left edge) of pulses forming an allowable speed write pulse string.

For instance, the over speed write pulse string shown in FIG. 2B is generated by changing the start timing of each pulse forming the allowable speed write pulse string in FIG. 2A. Comparing FIG. 2A with FIG. 2B, the pulses of the over speed write pulse string of FIG. 2B (i.e., write pulses (top pulses Pₜₒₚ, multi pulses Pₘₚ, last pulses Pₗₚ, and cooling pulse P_{cl})) are generated by advancing the start timings by a designated amount of time, respectively. Here, the amount of time being advanced is set by repeating a test writing operation several times.

By advancing the start timings of the write pulses Pₜₒₚ, Pₘₚ, Pₗₚ, it becomes possible to increase the pulse widths of the write pulses, respectively. As a result thereof, it becomes also possible to increase an optical energy irradiated from the optical pickup unit 120 onto the optical disk 10 during the data recording operation. The reason for increasing the optical energy is because low record-speed optical disks, by their nature, are relatively poor at receiving an optical energy, compared with the high record-speed optical disks. In short, by advancing the start timing of the write pulses by the designated amount of time, the pulse widths of the write pulses are increased, which in turn results in the increase of the optical energy. Therefore, even low record-speed optical disks can receive more optical energy.

In addition, by advancing the end timing of the last pulse Pₗₚ and the start timing of the cooling pulse P_{cl} by the designated amount of time, the cooling time for the over speed write pulse string has been reduced. This reflects the principle that when data is recorded at a high record-speed, the rotation speed of the optical disk is increased, and therefore so is the cooling effect of the optical disk.

As aforementioned, the over speed write pulse string in FIG. 2B was generated by changing the timings of the pulses that form the allowable speed write pulse string in FIG. 2A. This can be explained from a slightly a different perspective by stating, for example, the over speed write pulse string illustrated in FIG. 2B is generated by changing pulse widths or intervals between the pulses of the allowable speed write pulse string.

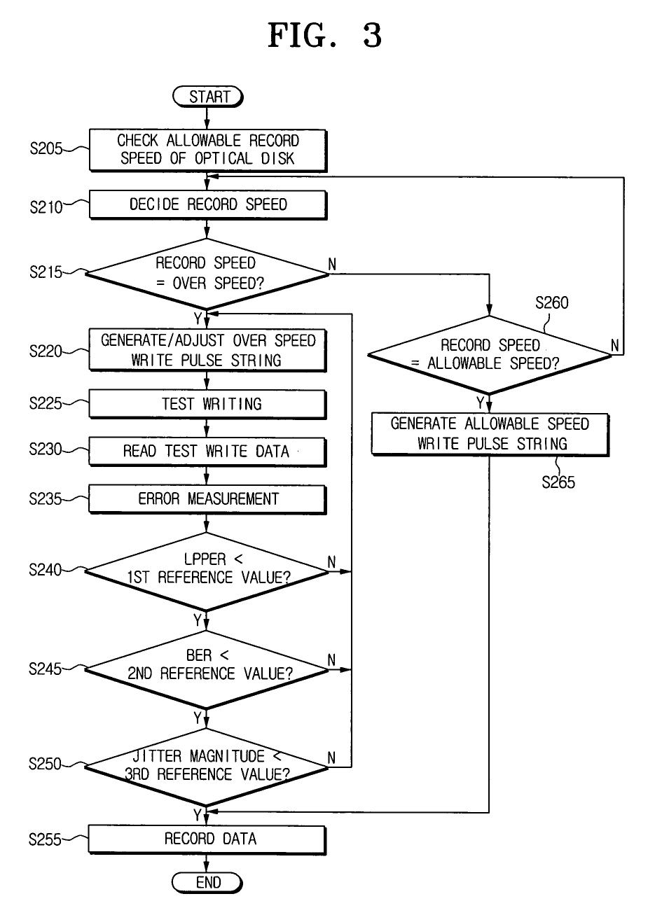

With reference to FIG. 3, the following will now explain how the optical disk recording device in FIG. 1 performs a high speed data recording on a low record-speed optical disk.

At first, the controller 150 checks an allowable speed of the optical disk 110 provided in the optical disk recording device (S205), and determines a record speed (S210). Since the optical disk recording device of the present invention is capable of recording data on the optical disk 110 at an allowable speed as well as at an over speed, the record speed being determined in operation S210 is either allowable speed or over speed.

The determination of the record speed in operation S210 can be made by a user, especially when the user wants to finish the data recording within a shorter amount time. Also, the record speed in operation S210 can be automatically set by the controller 150. This function comes in very handy and is useful when the data recording operation at the allowable speed is impossible or inappropriate mainly due to an operational error in the optical disk recording device.

If the record speed determined in operation S210 is the over speed (S215), the controller 150 issues a command to the optical pickup driving unit 130 to generate an ‘over speed write pulse string’, and the optical pickup driving unit 130, in response to the command, generates the over speed write pulse string (S220). The over speed write pulse string generated in operation S220 looks similar to the one illustrated in FIG. 2B. The thusly generated over speed write pulse string is applied to the optical pickup unit 120.

The optical pickup unit 120, being driven by the applied over speed write pulse string, performs test writing, that is, records data on a test (data) zone of the optical disk at the over speed (S225). The optical pickup unit 120 then reads the test write data from the optical disk 110 (S230). This data read from the optical disk 110 is applied to the error measurement unit 140.

The error measurement unit 140 measures an error included in the applied data (S235). In detail, the LPPER measurement unit 142 measures the LPPER, the BER measurement unit 144 measures the BER, and the jitter measurement unit 146 measures the magnitude of jitter. Then, the measured LPPER, BER, and jitter magnitude are applied to the controller 150.

The controller 150 determines whether the applied LPPER, BER, and jitter magnitude are less than the predetermined first, second, and third reference values, respectively (S240, S245 and S250). If any of the LPPER, BER, and jitter magnitude is greater than or equal to their respective reference values, the controller 150 generates a control signal to adjust the over speed write pulse string, and applies the control signal to the optical pickup driving unit 130.

In response, the optical pickup driving unit 130 adjusts the over speed write pulse string (S220). Afterwards, the operations S225 to S250 are repeatedly performed until all of the LPPER, BER, and jitter magnitude are lower than their respective reference values.

Meanwhile, if all of the LPPER, BER, and jitter magnitude are less than their respective reference values, the controller 150 applies the recording data to the optical pickup unit 120, and the optical pickup unit 120 records the data on the optical disk 110 at the over speed (S255).

When the record speed determined in operation S210 is the allowable speed (S260), the controller 150 issues a command to the optical pickup driving unit 130 to generate an ‘allowable speed write pulse string’. In response, the optical pickup driving unit 130 generates the allowable speed write pulse string (S265). The allowable speed write pulse string generated in operation S265 looks similar to the one illustrated in FIG. 2A. The thusly generated allowable speed write pulse string is applied to the optical pickup unit 120.

The optical pickup unit 120, being driven by the applied allowable speed write pulse string, records the data on the optical disk 110 at the allowable speed (S265).

As explained so far, the optical disk recording device of the present invention is capable of recording data on a low record-speed optical disk at the over speed, or otherwise recording data at a higher speed than that which the optical disk was designed to accommodate. As such, the present invention enables the user to finish data recording on the optical disk within a shorter amount of time, and to record data on the optical disk even when it is impossible to record data on the optical disk at an allowable speed due to an operational error of the optical disk recording device.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art. Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical disk recording device, comprising:
an optical pickup unit to be driven by an applied write pulse string to record data on an optical disk; and
an optical pickup driving unit to generate and apply an over speed write pulse string to the optical pickup unit so that the optical pickup unit records the data on the optical disk at a record speed exceeding an allowable record speed of the optical disk.

2. The device according to claim 1, wherein the optical pickup driving unit generates the over speed write pulse string by changing at least one of a start timing, end timing, pulse width, interval between pulses, or a combination thereof, of an allowable speed write pulse string, wherein the allowable speed write pulse string otherwise causes the data recording operation on the optical disk to be performed within the allowable record speed.

3. The device according to claim 2, wherein the optical pickup driving unit generates the over speed write pulse string by advancing the start timing of the pulses of the allowable speed write pulse string by a predetermined amount of time, the allowable speed write pulse string being formed of a top-pulse, multi-pulse, last-pulse, cooling-pulse, or a combination thereof.

4. The device according to claim 3, wherein the optical pickup driving unit generates the over speed write pulse string by advancing the end timing of the last-pulse by a predetermined amount of time.

5. The device according to claim 2, wherein the optical pickup driving unit generates the over speed write pulse string by increasing the pulse width of a top-pulse, multi-pulse, and last-pulse forming the allowable speed write pulse string by a predetermined amount of time, and reducing the pulse width of a cooling-pulse of the allowable speed write pulse string.

6. The device according to claim 2, wherein the optical pickup driving unit generates the over speed write pulse string by reducing an interval between pulses of the allowable speed write pulse string by a predetermined amount of time, the allowable speed write pulse string being formed of a top-pulse, multi-pulse, last-pulse, cooling pulse, or a combination thereof.

7. The device according to claim 1, further comprising:
an error measurement unit to receive data read from the optical disk, and to measure an error therein; and
a controller to control the optical pickup driving unit to generate the over speed write pulse string according to a result of the error measurement.

8. The device according to claim 7, wherein the error measurement unit comprises:
an LPPER (Land Pre-Pit Error Rate) measurement unit to measure the LPPER and apply the measured LPPER to the controller.

9. The device according to claim 8, wherein the controller generates the over speed write pulse string so that the measured LPPER is below a predetermined reference LPPER value.

10. The device according to claim 7, wherein the error measurement unit comprises:
a BER (Byte Error Rate) measurement unit to measure the BER and apply the measured BER to the controller.

11. The device according to claim 10, wherein the controller generates the over speed write pulse string so that the measured BER is below a predetermined reference BER value.

12. The device according to claim 7, wherein the error measurement unit comprises:
a jitter measurement unit to measure the jitter and apply the measured jitter to the controller.

13. The device according to claim 8, wherein the controller generates the over speed write pulse string so that the measured jitter is below a predetermined reference jitter value.

14. The device according to claim 7, wherein the error measurement unit comprises:
an LPPER (Land Pre-Pit Error Rate) measurement unit to measure the LPPER and apply the measured LPPER to the controller;
a BER (Byte Error Rate) measurement unit to measure the BER and apply the measured BER to the controller; and
a jitter measurement unit to measure the jitter and apply the measured jitter to the controller.

15. The device according to claim 14, wherein the controller generates the over speed write pulse string so that the measured LPPER, BER, jitter, or a combination thereof are below predetermined respective reference LPPER, BER, and jitter values.

16. The device according to claim 7, wherein the record speed is determined by the controller.

17. The device according to claim 1, wherein the record speed is determined by a user of the optical disk recording device.

18. An optical disk recording method, the method comprising:
generating an over speed write pulse string so that a data recording operation on an optical disk is performed at a record speed exceeding an allowable record speed of the optical disk; and
recording data on the optical disk using the generated over speed write pulse string.

19. The method according to claim 18, wherein the over speed write pulse string is generated by changing at least one of a start timing, end timing, pulse width, interval between pulses, or a combination thereof, of an allowable speed write pulse string, wherein the allowable speed write pulse string otherwise causes the data recording operation on the optical disk to be performed within the allowable record speed.

20. The method according to claim 19, wherein the over speed write pulse string is generated by advancing the start timing of the pulses of the allowable speed write pulse string by a predetermined amount of time, the allowable speed write pulse string being formed of a top-pulse, multi-pulse, last-pulse, cooling-pulse, or a combination thereof.

21. The method according to claim 20, wherein the over speed write pulse string is generated by advancing the end timing of the last-pulse by a predetermined amount of time.

22. The method according to claim 19, wherein the over speed write pulse string is generated by increasing the pulse widths of a top-pulse, multi-pulse, and last-pulse forming the allowable speed write pulse string by a predetermined amount of time, and reducing the pulse width of a cooling-pulse of the allowable speed write pulse string.

23. The method according to claim 19, wherein the over speed write pulse string is generated by reducing an interval between pulses of the allowable speed write pulse string by a predetermined amount of time, the allowable speed write pulse string being formed of a top-pulse, multi-pulse, last-pulse, cooling pulse, or a combination thereof.

24. The method according to claim 18, further comprising:
receiving data read from the optical disk, and measuring an error therein; and
adjusting the generated over speed write pulse string according to a result of the error measurement

25. The method according to claim 24, wherein the error is an LPPER (Land Pre-Pit Error Rate).

26. The method according to claim 25, wherein the over speed write pulse string is adjusted so that the LPPER is below a predetermined reference LPPER value.

27. The method according to claim 24, wherein the error is a BER (Byte Error Rate).

28. The method according to claim 27, wherein the over speed write pulse string is adjusted so that the BER is below a predetermined reference BER value.

29. The method according to claim 24, wherein the error is a jitter value of the optical disk.

30. The method according to claim 29, wherein the over speed write pulse string is adjusted so that the jitter value is below a predetermined reference jitter value.

31. The method according to claim 24, wherein the error is one of an LPPER, BER, jitter value, or a combination thereof.

32. The method according to claim 31, wherein the over speed write pulse string is adjusted so that the LPPER, BER, jitter value, or a combination thereof are below predetermined respective reference LPPER, BER, and jitter values.

33. A method of recording data on an optical disk, the method comprising:
increasing pulse widths of write pulses of an allowable speed write pulse string;
wherein an over speed write pulse string is formed so that the data is recorded on the optical disk at a record speed exceeding an allowable record speed of the optical disk.

34. The method of claim 33, wherein the pulse widths are increased by advancing start timings of a top-pulse, multi-pulse, last-pulse, or a combination thereof.

35. The method of claim 33, further comprising reducing a pulse width of a cooling-pulse of the allowable speed write pulse string.

36. The method of claim 33, further comprising:
reading one or more error values from the optical disk; and
adjusting the pulse widths so that the error values are less than predetermined reference values.

37. A method of recording data on an optical disk, the method comprising:
decreasing intervals between write pulses of an allowable speed write pulse string;
wherein an over speed write pulse string is formed so that the data is recorded on the optical disk at a record speed exceeding an allowable record speed of the optical disk.
